(19) United States
(12) Patent Application Publication
(10) Pub. No.: US 2009/0216655 A1
(43) Pub. Date: Aug. 27, 2009

(54) Method of auction - Motion Reverse Auction

(75) Inventor: Xuan Thanh Nguyen, Ha Noi (VN)

Correspondence Address: Nguyen Thanh Xuan, No 23 Van Mieu Str., Dong DA Dist, Ha Noi, VN

(73) Assignee: Xuan Thanh Nguyen, HA NOI (VN)

(21) Appl. No.: 12/331,251

(22) Filed: Dec. 9, 2008

(51) Int. Cl. G06Q 30/00

(52) U.S. Cl. 705/26

(57) ABSTRACT

Build one website of Online—Motion Reverse Auction (Bs2Cs E-Commerce) between suppliers of common consumer goods and consumers, who have demand to buy the same kind of product/goods.

The first Buyer set up a demand to buy one detail consumer goods/commodity with highest price he/she may accept to buy, enclose a Minimum Quantity for auction lot. Then, in “Waiting Period(s)”, other Buyers continuously set up demands to buy the same kind of product/goods, accept to buy with equal or lower prices than price of the first buyer had set up. Quantities are depended on their demand. Along with time and these “Waiting Period(s)”, total quantity requested to buy are increased continuously enclose accepted prices are decreasing.

Suppliers will bid together, in “Bidding Period(s)”, base biding price and quantity they can and have to supply with this sale bidding price.

The Final Winner of auction rounds is a supplier with lowest selling price simultaneous much have a big enough quantity of goods, equal or bigger total demand quantities from buyers.

### BACKGROUND OF THE INVENTION

1. Field of the Invention

The website will be applied for on-line trading of all common consumer goods/commodities, with quantity from big to very big, serve to any people, person, suppliers, manufacturer in Vietnam and USA, England, France, Japan, China. Language in Vietnamese, English, French, Japanese, Chinese, etc. . . . depend on each country having auction lots.

More particularly, this Invention relates to build one (01) website Online-Auction with the new method (Motion Reverse Auction—Type of Bs2Cs E-Commerce) between suppliers/manufacturers (Bidders to Sale) of common consumer goods, quantity always have trends to increase follow increasing of bidding time, for large of consumers, who have demand to buy the same kind of product/goods.

2. Background

If commodity/goods be sold with big quantity then Suppliers (sellers, re-sellers, distributors, and manufacturers) always be willing to sale with cheaper prices. As bigger quantity as cheaper price.

So, how to do to make a buying-selling environment/market, which adapt to the above mentioned buying-selling principle? This Invention of method “Motion Reverse Auction” will solve completely the inquiry said above:

To decrease price, commodity/goods be sold in Reverse Auction by invited sellers;

To increase buying demand quantity, in Waiting Period between auctions times/rounds, the demand of buying the commodity/goods be showed/sent/advertised (with highlight/attractive point is price is decreasing and will be a very low price) to invite/call for more buyers.

When quantity has being increased, the new auction time/round starts again and a new price will must be cheaper.

Great advantage point of this new auction method—Motion Reverse Auction is: Through auction times/rounds, buying demand quantity have tendency towards increase (because of selling bid price is decreased) and this tendency excites again decreasing of selling price.

Consumers will have most benefits/profits and suppliers also have a business deal with big quantity. Huge of buyers with demand of buying the same one commodity/goods and supplier having big quantity for that commodity/goods will have chances meet together by and via Global Internet environment—Online e-Commerce:

Buyers: Many buyers located in different locations/regions may attending to buy a same kind of goods with buying price as low as possible. This advantage only available in Internet Communication environment nowadays; In the past, it could not available.

Suppliers: Sold directly with big quantity from their warehouses/stocks/stores, to a huge group of buyers having goods receiving address at (or nearly) their warehouses/stocks/stores; help to optimality process of manufacture and sale of products.

### SUMMARY OF THE INVENTION

The Invention makes the new method, principle, process of on-line auction: Reverse Auction with Motion quantity (Motion Reverse Auction—MRA). By this new MRA process, when finishing an auction will lead to result that a biggest quantity of goods were sold out with possible lowest price, that mean it encourages trading transactions with huge selling quantity (in Sellers side) and huge buyers will have lowest buying price together for the same one commodity/goods.

To start one on-line MRA, the first Buyer set up a demand to buy one (01) detail consumer goods/commodity with highest price he/she may accept to buy, called is X1 price—Ceiling price. (X1 is lower about 20% than Xo price—existing retail price of market), enclose a Minimum Quantity—Qm for auction lot (Qm is minimum quantity of goods which Buyer hope to invite/lead other Buyers to buy together) to attract/invite Sellers, in order to have lowest buying price; Minimum quantity—Qm at beginning should not be too low or too high (about 5˜10 units is the best, because of the quantity are able to increase later). Consumer goods (subject to buy) are goods with Standard Configuration and the best is 100% brand-new in box (to avoid commercial conflict/dispute about quality of the goods later).

Then, in “Waiting period”—Period of time between auction times/rounds, i.e. between “Bidding Periods”, other Buyers continuously set up demands to buy the same kind of product/commodity/goods, accept to buy with equal or lower price than price of the first buyer had set up. Quantity is free, depend on them. Go with time and through these “Waiting Periods”, total of demand quantity has continuously increased enclose accepted price has decreased.

Suppliers (Bidders) will bid together, on-line, real time, in “Bidding Period” (2 auction times/rounds per day), base on bidding price and quantity they can and have to supply with this sale bidding price.

The Final Winner of auction rounds is seller with lowest selling price simultaneous have a big enough quantity of goods to adapt total demand quantities from buyers. Demand quantity to supply (winning quantity) is depended on buyers' accepted prices and this price is equal or higher than winning price.

Sellers Will Lose if:
Have enough quantity of goods for the demand but bidding prices are higher than final winner's price; or
Have lower of equal prices than final winner's price but have not enough quantity of goods; or
SaleItNow case was accepted by a Seller and auction lot terminates right away, earlier than End Time GMT.

Some Buyers could not Buy the Goods if:
Their accepted prices are lower than winning sale price; or
Their accepted price equal than winning sale price but bidding time came to End Time GMT but there were not new Sellers (Bidders) who adapt for new increased quantity; or
SaleItNow case was accepted by a Seller and auction lot terminates right away, earlier than End Time GMT.

### BRIEF DESCRIPTION OF THE DRAWINGS

FIG. 1-1: Table of operating time of Motion Reverse Auction times/rounds

FIG. 2-1: Form of Waiting List

FIG. 2-2: Real Example of the “Form of Waiting List” (FIG. 2-1)

FIG. 2-3: Form of Waiting List be sent to Buyers

FIG. 3-1: Information Table Form

FIG. 3-2: Real Information Table Form

FIG. 4 (02 pages): Operating Process . . . .

FIG. 5-1: Schematically Illustrates an Implantation of a Method of M.R.A

FIG. 5-2: Flowchart Illustrates a Method of M.R.A

FIG. 5-3: Chart of the new Motion Reverse Auction method

FIG. 5-4: Comparison Chart between new M.R.A type and existing types of auction method

FIG. 6 (02 pages): Description of Database system/records

### PRINCIPLE & NAME OF THE INVENTION

### The New Method of Auction: Motion Reverse Auction (M.R.Auction)—MRA

1—New Points of the Invention:

1. Principle of Motion Reverse Auction: Auction with Always Changed Quantities, increasing to the end of auction time, in order to sure those Buyers will have lowest buying price.

2. Divide auction lot by many non continuous auction times/rounds, between them are waiting periods of time without any bidding actions.

3. In waiting periods, demand quantity for buying-selling are changed with tendency towards increase.

4. Suppliers (Bidders) when participating to MRA must consider and bid on price and quantity.

5. Buyers request themselves about quantity but buying price is depended on Seller. Buyers offer only wishing price to buy (ceiling-reserve price) but can not negotiate/bid buying prices. Final buying price is bid by Sellers but it is mostly depended on requested goods quantities from Buyers.

6. Oppositely, Sellers offer themselves about price but quantity always changes increasingly and it is depended on buyers, at price want to sale.

7. Final Buying-Selling price is depended on both Sellers and Buyers, in direction as more buyers as cheaper price.

8. Type Bs2Cs e-commerce: A new way in trading transaction by which, Business(S) serve to Customer(S).

2—Advantages of the New Method of Auction: the New Auction Method Will Help:

Buyer Party:
Bought goods (one fixed kind of goods) with the lowest price between wholesales/suppliers and THE NEW PRINCIPLE FOR TRADING TRANSACTION IN THIS CASE THAT IS: If buyers invite/lead more and more, as much other/new buyers (for the same kind of goods) then opportunity to have as lower price of the goods.
Many buyers located in different locations/regions may attend to buy a same kind of goods with buying price as low as possible. This advantage only available in Internet Communication environment nowadays; in the past, it could not available.

Seller Party:
Sold goods with big quantity (but have to meet a demand quantity of Buyer Party) at price lowest if compared with other sellers AND acceptable themselves.
Sold directly with big quantity from their warehouses/stocks/stores, to a huge group of buyers having goods receiving address at (or nearly) their warehouses/stocks/stores; help to optimality process of manufacture and sale of products.

3—Different Points from Existing Auction Methods.

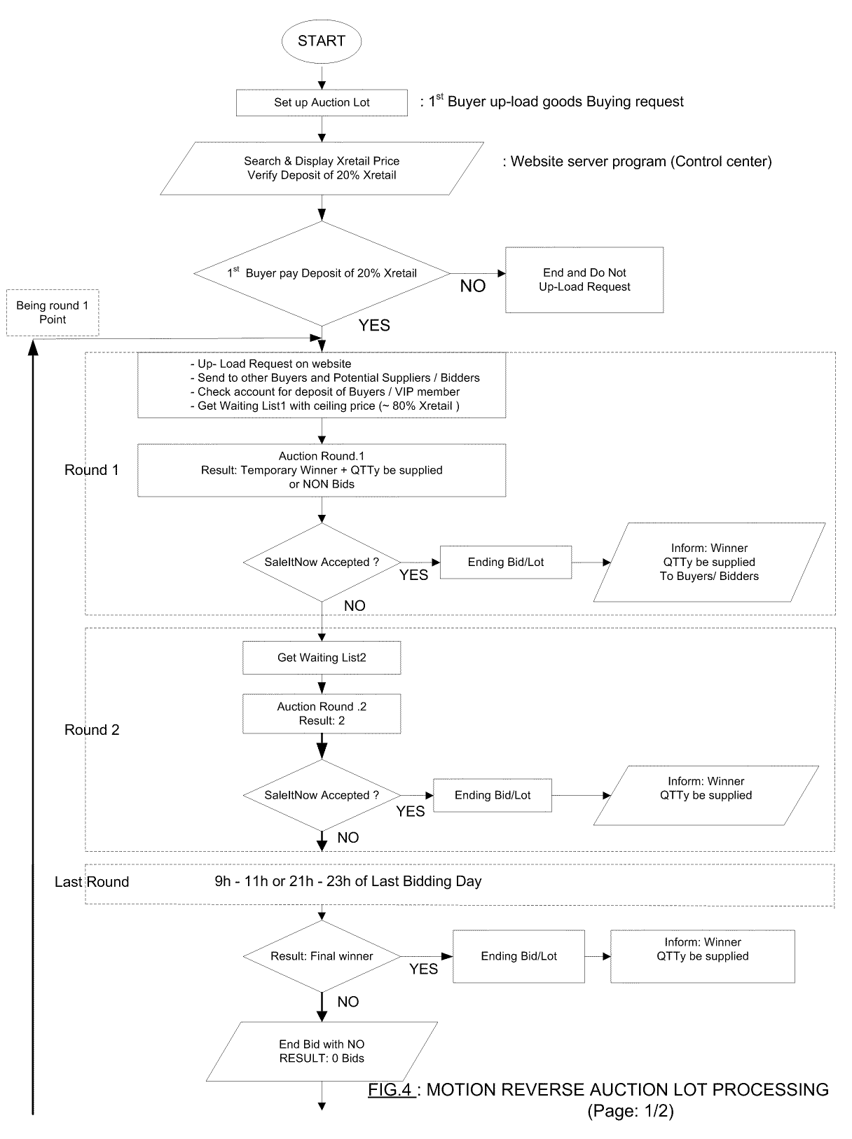

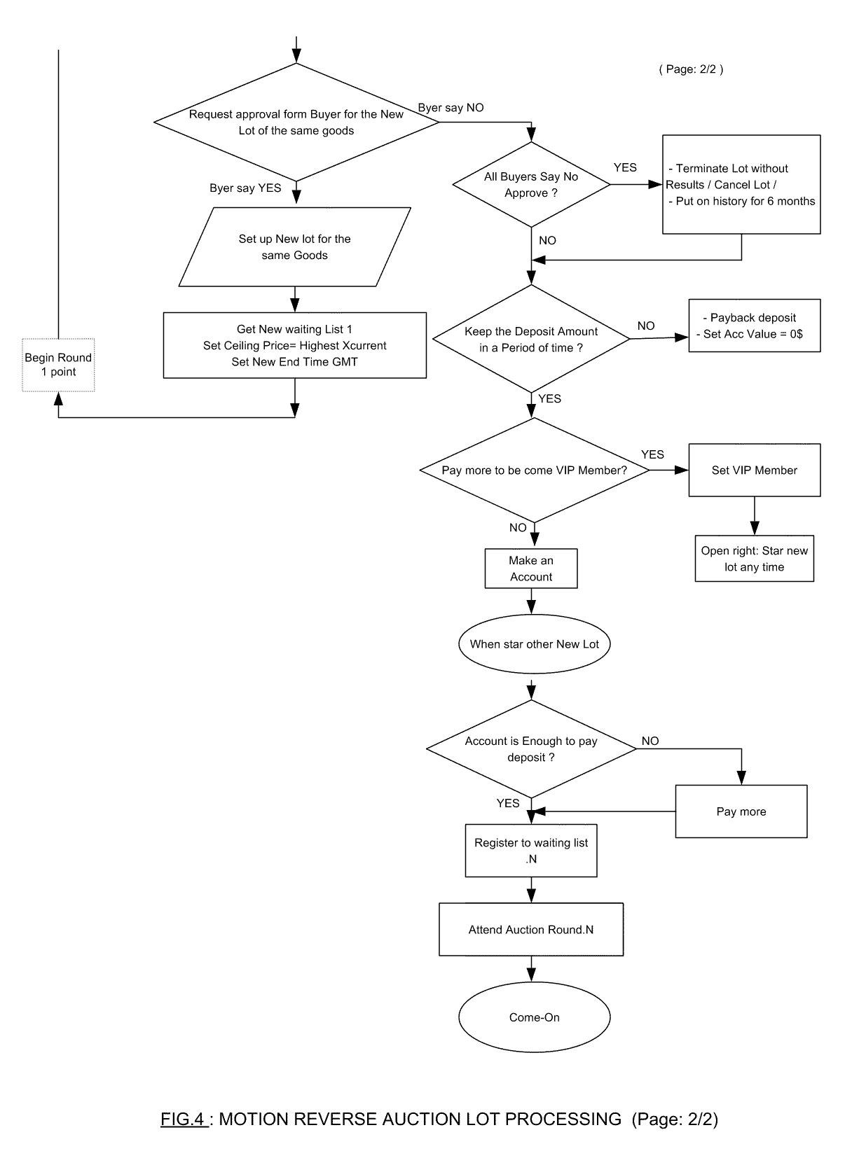

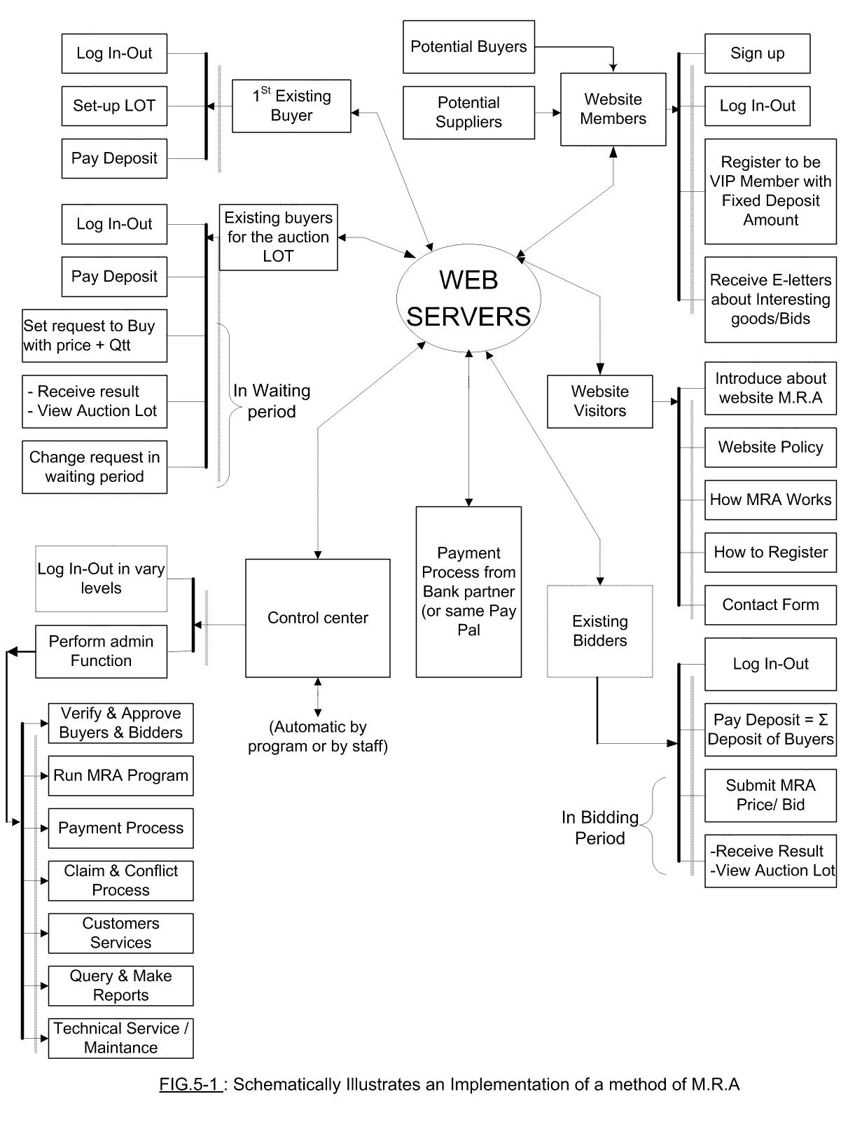

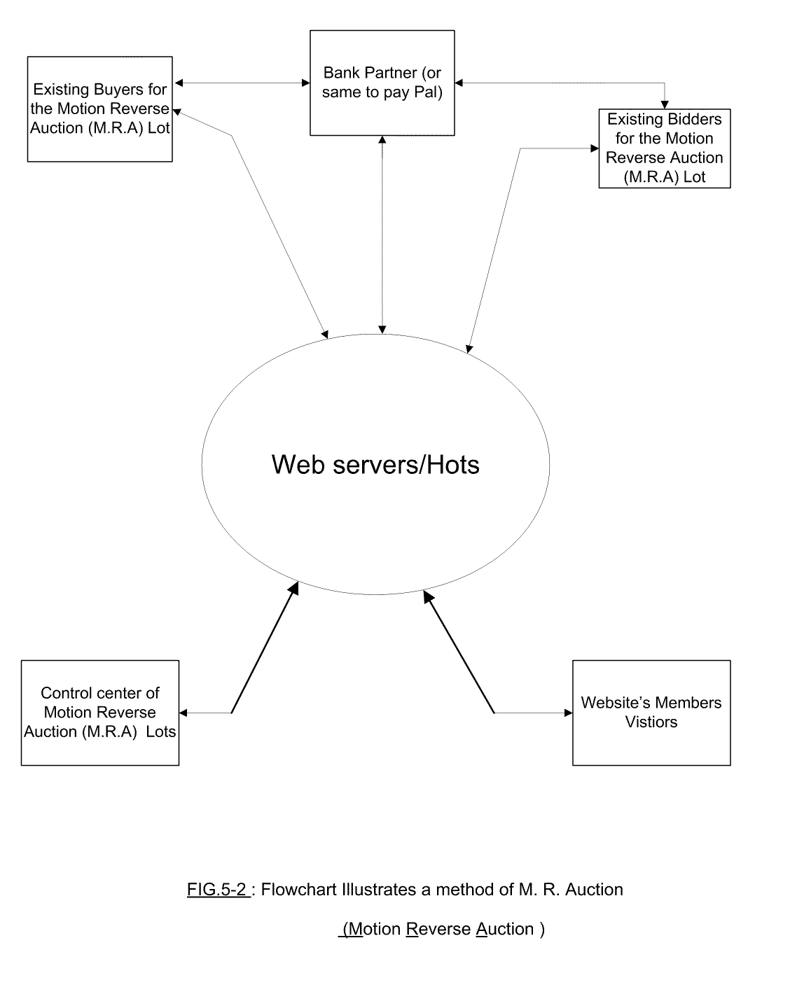

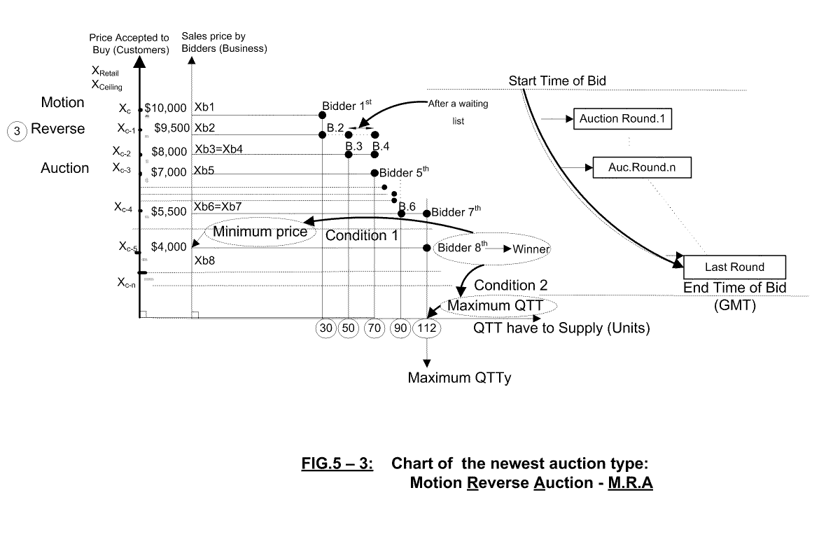

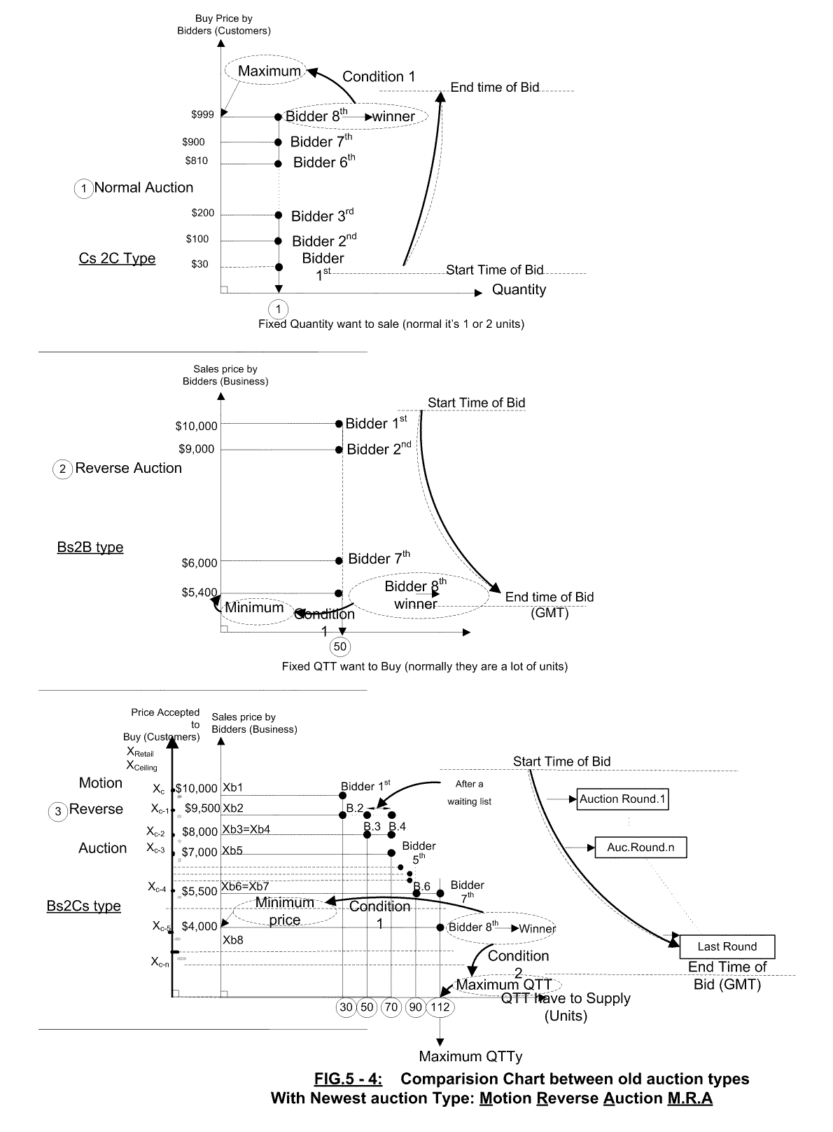

(See description drawing number FIG. 5-4: Comparison Chart between new M.R.A type and existing types of auction method)

Old Auction/Bid Methods, Existing Moment:
EBay type: Cs2C and it is standard Auction: Fixed Quantity, Prices are increase with time.
Bs2B type and it is Reverse Auction: Fixed Quantity, Prices are decrease with time.
Quantity of final buyers is only ONE (01) buyer.
Existing auction/bid are using, show only BuyItNow prices.
BuyItNow prices is a fixed number.

Different Points:
Point 1. Use new method Bs2Cs (Business' To Customers)
Point 2. Goods Quantity of auction are always changed with tendency towards increase together with time until the End Time of the auction (End Time GMT).

Different point from existing auctions is: Demand Quantity for buying-selling are Fixed Number.
Point 3. An auction lot is divided by many non-continuous auction times/rounds, between them are waiting periods of time without any bidding actions.

Different point from existing auctions is: Auctions are bided continuously and there is only one round/unique bid turn.
Point 4. In waiting periods, demand quantity for buying-selling are changed with tendency towards increase.

Different point from existing auctions is: There are not waiting periods in order to increase transaction goods quantity, therefore goods quantity in other existing auction types is only fixed number.
Point 5. Waiting List is a place where (existing, new) offer request, changes their demand to buy goods (about quantity, wishing buy price) in waiting periods of time between auction rounds.

Different point from existing auctions is: There are not waiting lists as said above.
Point 6. Suppliers (Bidders) when participating to MRA must consider and bid on price and quantity.

Different point from existing auctions is: Bidders usually consider on price.
Point 7. Waiting List is helpful information for sellers when they considering offer bid, beside information about current bidding prices and current supplying quantity of competitors—other sellers (in bidding period of time).

Different point from existing auctions is: Normally, sellers only consider and offer about price but no need other information such as requested supplying quantity will be more when offering a lower price; such as maximum quantity of competitors—other sellers can supply, etc. . . . .
Point 8. NEW PRINCIPLE IS: If buyers invite/lead more and more, as much other/new buyers (for the same kind of goods) then opportunity to have as lower price of the goods. The Invention make chances of increasing buyers/buying quantity, quantity will increase due to price's decreasing.
Point 9. When an MRA closed, there will be MANY Buyers have goods (not only ONE final buyer have goods in old/existing auction methods).
Point 10. Final Winner of auction round is seller not only with lowest selling price but much have a big enough quantity of goods. Seller with as lower selling price AND as much goods quantity then have more opportunity to become the final Winner.
Point 11. There is SaleItNow price. SaleItNow is finishing price for transaction/auction round and go to the end right away, help to meet right away demand/wish of Buyer Party meanwhile Seller Party also meet demand/wish to sales quickly, with his limited quantity (because if he let auction round in being longer time, then competitive sellers who have bigger quantity will get an advantage over him/someone else). SaleItNow price always be set up right after having temporary winning result (with temporary Winner) in auction times/rounds and have value is 10% lower than current selling price, with existing selling quantity (Later on, MRA program will configures: includes new adding quantities OR only quantities of temporary winner).

Different point from existing auctions is: using, show only BuyItNow price
Point 12. Due to competition between sellers about also goods quantity they have and be able to supply beside pricing factor, so if choose SaleItNow option, beside finishing transaction immediately, to help seller to meet their demand/wish to sales quickly, but also to help sellers with his limited quantity will win a bid in time with quantity he having, but have to accept to sale with 10% lower price than current selling price of temporary winner—with same quantity (because if he let auction round in being longer time, then competitive sellers who have bigger quantity will get an advantage over him/someone else; and when requested quantity be over quantity he having then basically he will not be able to come on the bid, unless he accept to re-buy more from other seller later).
Point 13. Value of SaleItNow price are always changed and decrease with time.

Different point from existing auctions is: Value of BuyItNow price is a FIXED Number.
Point 14. For Buyers: Many buyers located in different locations/regions may attending to buy a same kind of goods with buying price as low as possible. This advantage only available in Internet Communication environment nowadays; in the past, it could not available.
Point 15. For Sellers: Sold directly with big quantity from their warehouses/stocks/stores, to a huge group of buyers having goods receiving address at (or nearly) their are houses/stocks/stores; help to optimality process of manufacture and sale of products.
Point 16. A finished auction lot will lead to result that a biggest quantity of goods were sold out with possible lowest price, that mean it encourages trading transactions with huge selling quantity (in Sellers side) and HUGE buyers will have lowest buying price together for the same ONE (01) product/goods.
Point 17. Goods on the Motion Reverse Auction floor have to be identical type: Because particularity of transaction is many buyers and many sellers participate together, so in order to have justice between sellers and no disputes about quality of goods between sellers and buyers, then g Goods on the Motion Reverse Auction floor have to be identical type (Example: same model, 100% brand-new, new in box, never used, manufactured on 2xxx year, . . . ).
Point 18. Both buyers and sellers have to pay a deposit: Because particularity of transaction is at the finishing time (i.e. have official transaction contracts) there will be many buyers (Customers) and large goods quantity will be supplied by bid winning seller (winner), with correlative winning price, so in order to ensure highest interests for every buyers as well as every sellers, pay a deposit policies are applied and those deposit amount will be taken from cancelling parties (cancel themselves to perform transaction contracts) and be shared equally to remaining parties of contracts.
Point 19. Particularity of VIP member: is there are available enough amount in their accounts on Motion Reverse Auction floor in order always have right to participate (buy-sale) at any time for a commodity they interest in without lose time to pay a deposit and lose opportunity to participate when bid time go nearly the end time (i.e. when period of time from register to moment be confirmed paid a deposit are more/bigger than period of left time of interesting bid).

4—Total New Invention Points Request to be Protected by USPTO, WIPO

Are nineteen (19) different points said above, from Point 1^{st} to Point 19^{th}.

5—Special Profits/Benefits Come to World Trade from this Patent—Motion Reverse Auction Method:

1. Increase trading transactions, in quantity of goods/commodities as well as trading value;

2. Optimality process of manufacture and sale of products for suppliers/manufacturers;

3. Decrease cost of sales management;

4. Decrease stocking time/time of overstock resulted in increase profits for suppliers/manufacturers;

5. Customers have more chances to buy goods/commodities/products with lowest prices;

6. Bring public/common profits/benefits to the World Trade such as floating/working capital will be faster returned resulted in value on each capital currency be increased, to increase surplus value meanwhile help consumers having much more profits/benefits.

7. And the end, create a Revolution in trading of consumer goods: Through assistance of online transaction via Internet, by the New Motion Reserve Auction Method, goods/products will be sold with biggest quantity to buyers at lowest price, in any locations/regions of country or on the world, help to balance quickly, exactly and optimality between Demanding element and Supplying element.

### DETAILED DESCRIPTION

### The Auction Principle with New Method

Motion Reverse Auction—M.R.Auction—M.R.A (BS2CS E-Commerce Type)

See description diagrams/figurations/charts/Schemata below:

FIG. 4 (02 pages): Operating Process

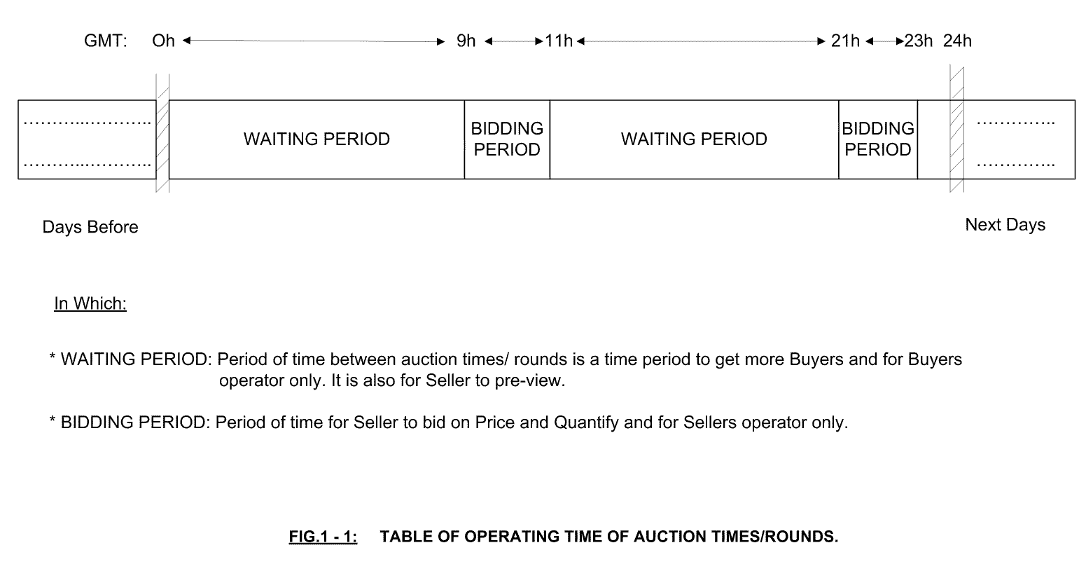

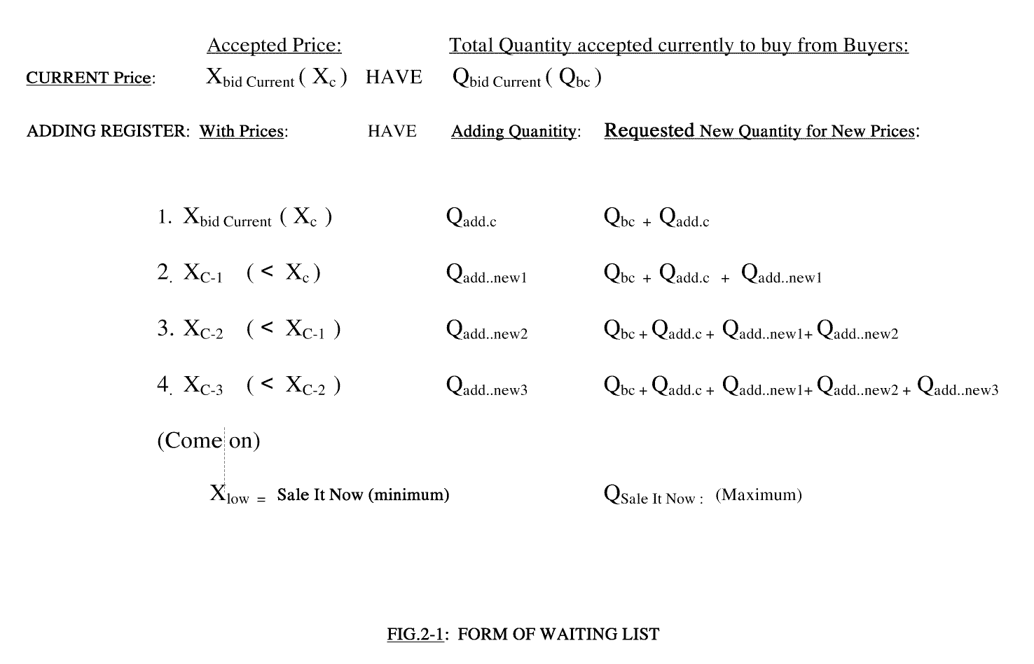

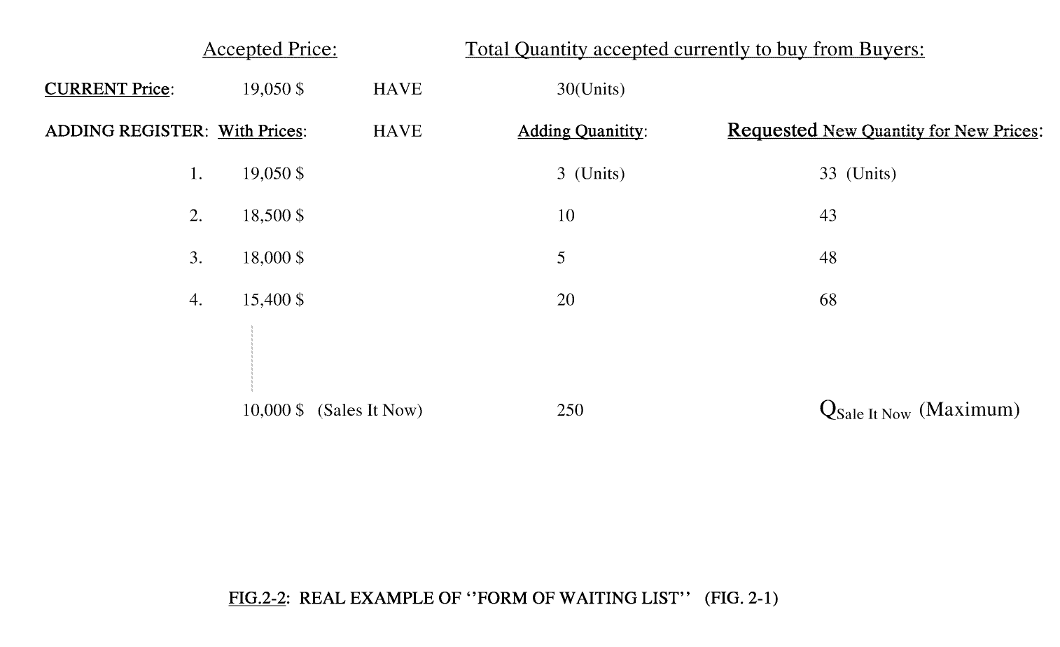

FIG. 5-1: Schematically Illustrates an Implantation of a Method of M.R.A

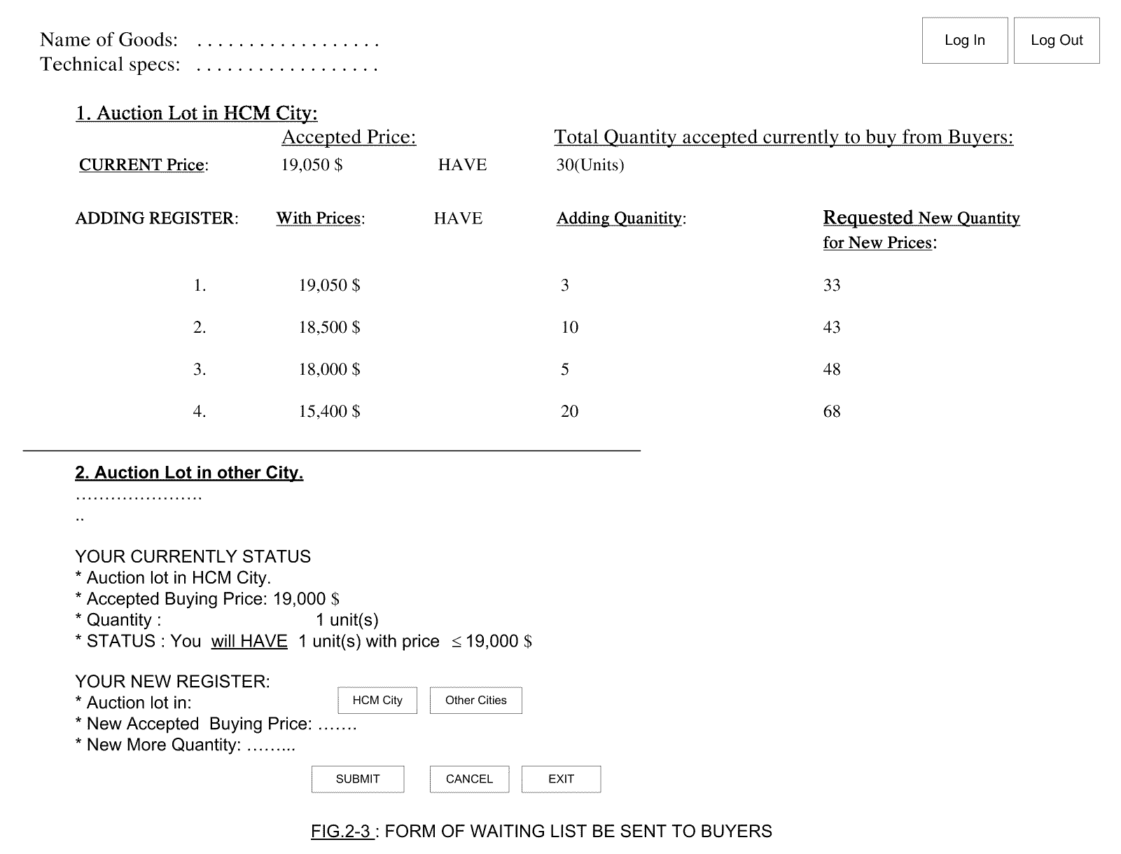

FIG. 5-2: Flowchart Illustrates a Method of M.R.A

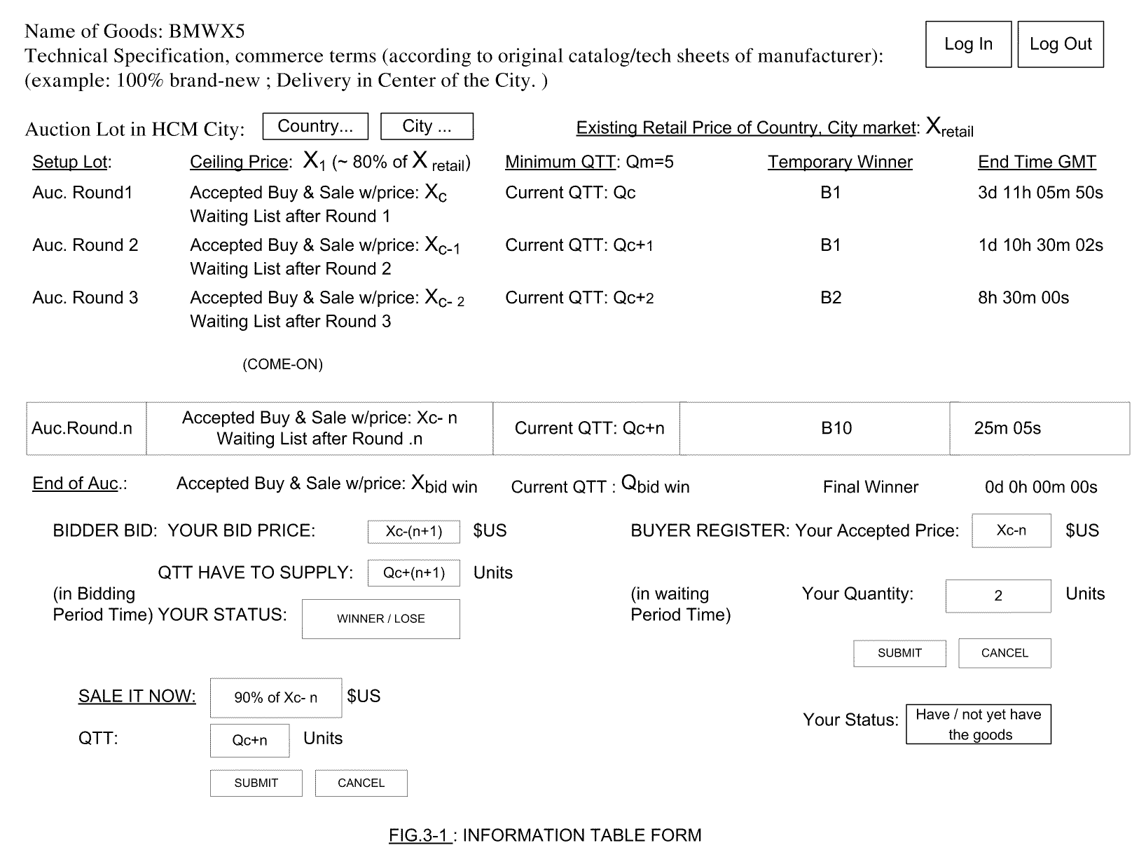

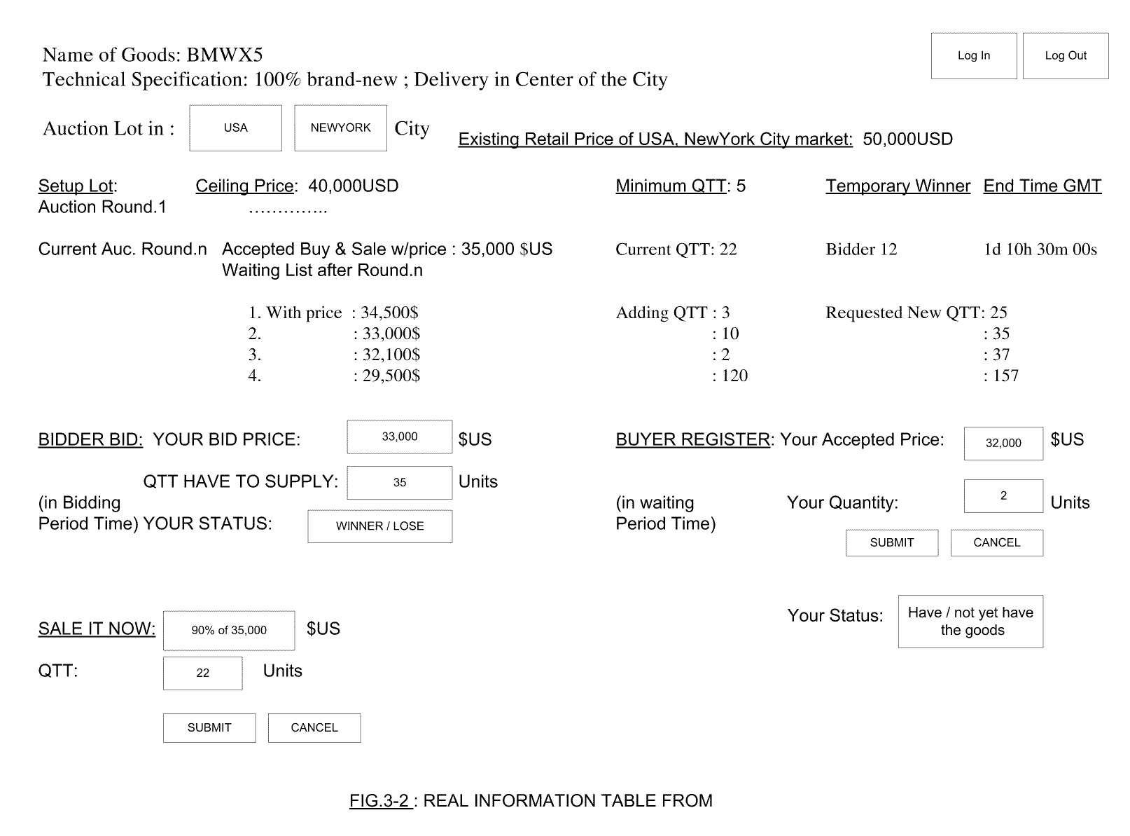

FIG. 5-3: Chart of the new Motion Reverse Auction method

FIG. 5-3: Comparison Chart between new M.R.A type and existing types of auction method

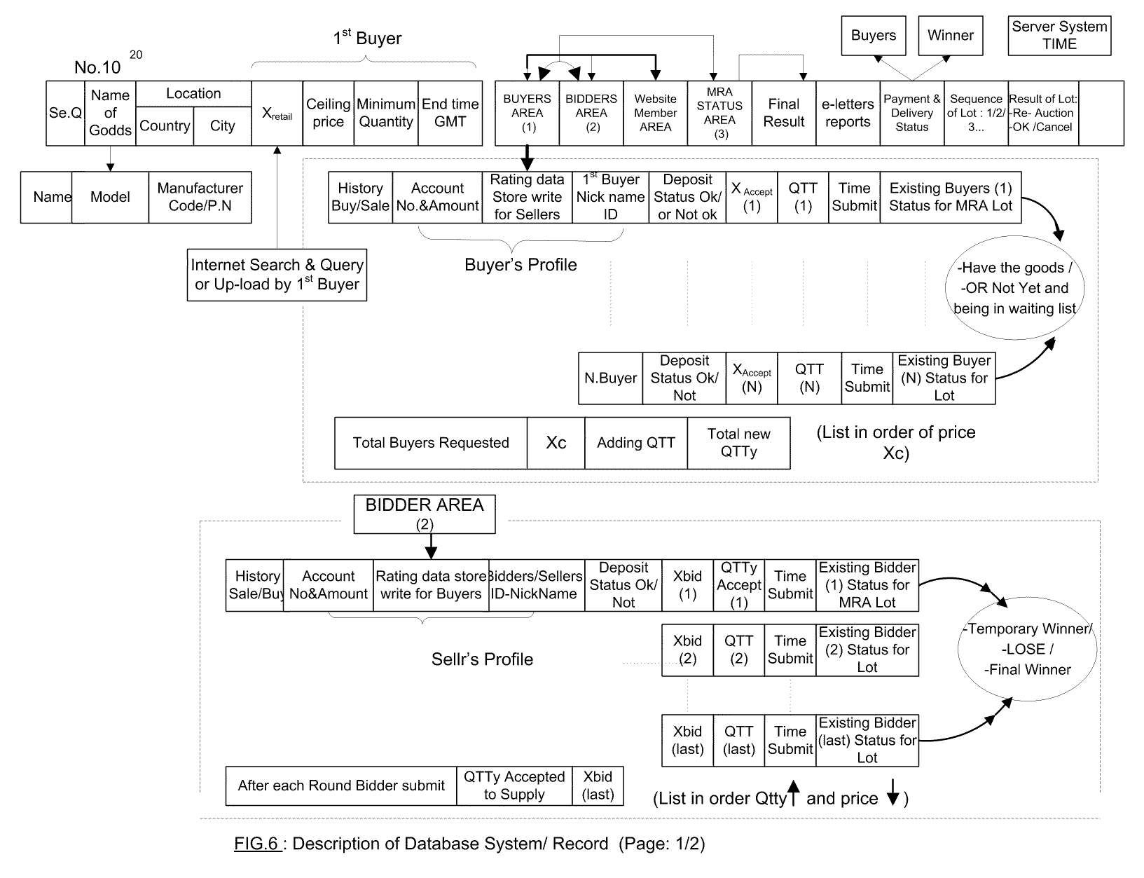

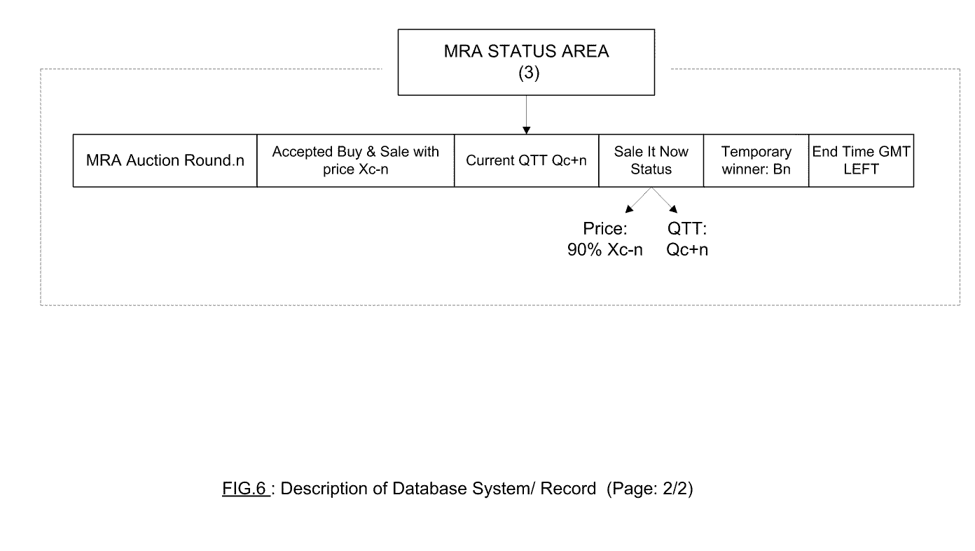

FIG. 6 (02 pages): Description of Database system/records

1. The first Buyer set up a demand to buy 1 detail consumer goods/commodity (common or not common; if it is common goods then easy to have lower price because of there are more buyers; example: a Tivi LCD 50″ SONY model 50PX2 cost about US$6,000 or a car BMW model X5, cost about US$60,000) with highest price he/she may accept to buy, called is X1 price—Ceiling price. (X1 is lower about 10% than Xo price—existing retail price of market).

He/She can set up SaleItNow price—XLow (equal 50%˜80% of Xo or it's set up automatically by Website Administrator: always have new value lower than 15%˜20% of Current bided price—XbidCurrent—Xc), enclose a Minimum Quantity—Qm for auction lot (Qm is minimum quantity of goods which Buyer hope to invite/lead other Buyers to buy together) to attract/invite Sellers, in order to have lowest buying price;

Minimum quantity—Qm at beginning should not be too low or too high (about 5˜10 units is the best, because of the quantity are able to increase later). Consumer goods (subject to buy) are goods with Standard Configuration and the best is 100% brand-new in box (to avoid commercial conflict/dispute about quality of the goods later). Options Accessories/Parts maybe refer as other small goods or Buyer can buy later and/or negotiate with Sellers to have price of it.

2. Information about these is a first Buyer for a goods will be sent/public/advertise to other potential Buyers and to Sellers (wholesales, distributors, retails, manufacturers, etc. . . . )

3. The first Buyer or Website Admin will set up the End Time of the auction lot (may be day 10^{th}/20^{th}/30^{th} of month or any fixed day).

4. Working Process of an Auction Lot and New Auction Law/Prescript will be described as following: (This principle is set by website):

| | | | | | | |
|---|---|---|---|---|---|---|
| Waiting | GMT: | | | | | |
| Period | 0 h | 9 h | 11 h | 21 h | 23 h | 24 h |
| ................ | :: | :: | :: | | :: | ::............ |
| Days before | ::Waiting Period | Bidding Period | Waiting Period | Bidding Period | | :: next day |

(See description drawing number: FIG. 1-1: Table of operating time of Motion Reverse Auction times/rounds)

a/ There are 2 times/rounds per day (RED color in above Diagram: 9 h-11 h; 21 h-23 h) for reverse auction between Sellers (may be decrease to 1 time)—Bidding Periods

b/ Waiting Period: Period of time between auction times/rounds is a time to get more Buyers (Quantity maybe increase or unchanged until the End Time). Waiting Periods are for Buyers (existing or new) to add, subtract, and change their auction information: add more/subtract quantity, change wished buying price, cancel . . . (BLACK color in above Diagram: 0 h-9 h; 11-21 h; 23 h-24 h next day).

c/ Winner (Seller) after each auctions time/round have to naturally accept a selling contract having the bided price AND goods quantities at that auctions time/round (Qc—CurrentQuantity). If after this auctions time/round, there are not new Sellers or there are not any lower bidding price, then the Temporary Winner remain their winning right until the End Time. For new Buyers (new adding quantity=Qac—CurrentAddingQuantity), they are maybe or maybe not accepted by the Temporary Winner. The new quantity is only accepted when having new bidding price (is equal or lower than bided price of the Temporary Winner) with that new quantities.

d/ Quantity will be fixed before each auctions time/round (i.e. at 9 h and 21 h).

e/ As for new Buyers with new adding quantity (same price) in Waiting List, they have to naturally accept to buy with lowest price of last auctions time/round and maybe can not buy the goods if Temporary Winner do not accept the new quantity and there are not other Sellers to auctions with the new quantity but with unchanged price or new price lower.

(See description drawings number:

FIG. 2-1: Form of Waiting List

FIG. 2-2: Real Example of the “Form of Waiting List” (FIG. 2-1)

FIG. 2-3: Form of Waiting List be sent to Buyers)

f/ If Seller accept SaleItNow (XLow) price then auction lot will be terminated right away at SaleItNow price with the quantities at that auctions time/round but no need to wait until the End Time of auction lot.

g/ SaleItNow or:

g.1—Only displayed in final auctions time/round (nearest to the End Time) and equal about 50%˜80% of Xo—existing retail price; Or:

g.2—Displayed in first auctions time/round and always have new value lower than 15%˜20% of Current bided price—XbidCurrent—Xc) (these rates are prior set by website program/Administration), to ensure highest benefit for Buyers, gain advantage for Seller who want to buy right away his goods quantities.

h/ For new Buyers with wishing price is equal (=) or lower than (<) Current bided price—XbidCurrent—Xc), they will be listed in a Wish List and this list are public advertise to Sellers who are participant in the auction lot.

Waiting List have form:

Currently :

| | Total Current Qtt |
|---|---|
| Accepted Price: | Accepted to buy: |
| XbidCurrent | QbidCurrent-QbC |

Adding Register:

| | Adding Goods Qty | |
|---|---|---|
| Accepted Price: | from new Buyers: | Total New Quantity: |
| XbidCurrent = . . . | Qadd.c, example = 2 | QbC + 2 |
| Xc-1 (<Xc) = . . . | Qadd.new1 = 1 | QbC + 3 (2(Qadd.c) + 1) |
| Xc-2 (<Xc-1) = . . . | Qa.n2 = 2 | QbC + 5 (2(Qadd.c) + |
| | | 1 + 2) |
| Xc-3 (<Xc-2) = . . . | Qa.n3 = 3 | QbC + 8 (2(Qadd.c) + |

| | | 1 + 2 + 3) |
|---|---|---|
| : | (come on) | : |

| | |
|---|---|
| XLow = SaleItNow (minimum) | QsaleItNow (maximum) |

i/ In Bidding Period: Seller bid Equal Price (=) In next auctions time/round, other Seller can remain Xc price (i.e. bid with Equal Price) for new quantity (bigger) and become new Winner.

k/ Seller bid lower Price (<): He have to sure a new quantity for this new lower price then he become new Winner.

l/ Minimum value between new bidding price and Current bided price (except case with Equal Price but bigger quantity) are 2%˜4% Xo or $10˜$20˜$100 depend on kind of goods and set by Website Adm.

m/ New Buyers can change their wishing price (should be higher) if after one auctions time/round but there are not Sellers accept new quantity bigger enclose new price lower.

n/ Website Admin: Email existing auction lots to Sellers-Business(S) and Buyers-Customer(S) who are interested in the auction goods (Wish List/Check List).

o/ Existing Auction Information Table for existing Sellers and Buyers (send separately or log-in with Account): is existing price and quantity situation (similar to the above mentioned list but it's information table to assistance/notice in auction lot, same to Auction History to each Seller separately and each Buyer separately)

p/ Existing Auction Information Table for the same kind of goods (Public Display): This information table will display fully existing Auction LOTS for the same kind of goods, but these Auction LOTS are happening simultaneously in different locations (to serve for locations/regions very far from each others, example in Hanoi, HCM City, DaNang City in Vietnam or FL, CA, LA, NY, Washington D.C. in USA, . . . ) for the purpose of Sellers/Business(S) make balance/arrange of goods quantities will be sold from 1 or many of their warehouses.

For example only, INFORMATION TABLE maybe have a form as below:

Name of goods:
Technical Specification, Commerce terms (according to original catalog/tech sheets of manufacturer)
(Example: 100% brand-new in box, or Never used, in box; Delivery in City Center.)
Auction LOT in HCM City: Existing Retail Price of HCM market: Xretai
Setup Lot: Ceiling Price: X1 (~80% Xretail) MinimumQTT: Qm = 5

| | | Temporary Winner | EndTimeGMT |
|---|---|---|---|
| Auction Round 1 | | | |
| Accepted Buy&Sale w/price: Xc | Current QTT: Qc | B1 | 3d11h05m50s |
| Waiting List after Round 1 | | | |
| Auction Round 2 | | | |
| Accepted Buy&Sale w/price: Xc-1 | Current QTT: Qc + 1 | B1 | 1d10h30m02s |
| Waiting List after Round 2 | | | |
| Auction Round 3 | | | |
| Accepted Buy&Sale w/price: Xc-2 | Current QTT: Qc + 2 | B2 | 0d08h30m00s |
| Waiting List after Round 3 | | | |
| (come on) | | | |
| Auction Round.n | | | |
| Accepted Buy&Sale w/price: Xc-n | Current QTT: Qc + n | Bn | -d--h--m--s |
| Waiting List after Round n | | | |
| End of Auction: | | | |

| | | |
|---|---|---|
| Accepted Buy&Sale w/price: XbidWin | Current QTT: QbidWin | Final Winner 0d00h00m00s |

(See more decription FIG. No FIG. 3-1: Information Table Form and FIG. 3-2: Real Information Table Form)

5. Responsibility of Buyers and Sellers:

5.1 Regulations:
Place for goods delivery is a Collecting Warehouse in big cities, where was prior assigned at beginning of auction lot, example warehouse of supplier or of Post Company in HoChiMinh City, DaNang, Hanoi/or in any warehouse at Center of FL, CA, LA, NY, . . . .
Packing, freight costs TO the Collecting Warehouse are borne by Seller.
Freight costs FROM the Collecting Warehouse TO customer home are borne by Buyers (except if Sellers have other promotions).
Within a same city (or within Radial of xx km) maybe free for delivery, depend on acceptance level of Seller.

5.2 Deposit: (in Order to have the Right to Participate in Auction Lot—Similar to Bidding/Auction Guarantee).

Base on e-commerce law or business environment/practice in each country, this deposit rule is mandatory or not. Example:

Buyers deposit 20% of Xo (20% of retail price) if Minimum Quantity of auction lot are 5.

Buyers deposit 10% of Xo (10% of retail price) if Minimum Quantity of auction lot are 10.

Sellers deposit or confirm to deposit amount=Total of deposited of Buyers.

5.3 When Final Winner cancel the contract: If a commercial contract came in force (i.e. an auction lot successfully) but Seller Party do not perform then he/she will lose deposit amount for other else Buyer parties and this deposit amount will be divided into equal parts to Buyers and Second Winner will be invited to negotiate a contract with existing detail terms (sale price+quantity) or with own detail terms of Second Winner, which were bided.

5.4 When one Buyer cancel the contract: then deposit amount of the cancelled Buyer will be paid to the Seller. Other else Buyers remain the right to buy with bided win price. Any cases of infringe will be recorded in details, rating for each Buyer and Seller to reference for, prevent from . . . other auction lots later.

Buyer will have a nick-name (maybe have various nick-name, separate for different auction lots) when participating auction lot (bidding) in order to secure confidential information of prices, quantity in stock between Sellers. Official details information of Sellers are registered only for website. Rating Points have being assign continuously to their nick-names, after each successful auction lot.

6. Register:

Buyers and Sellers have to have, provide details contacting information, such as company office address, tel, fax, email, address of place for delivery—collecting warehouse address (Seller) and address of goods receiving, home address, tel, email (Buyer).

7. Participance Fees/Tariff:

1% (or 2%˜3%) from Seller/per total contract value. OR:

2% (or 3%˜4%) from Buyers/per separately sub-contract value (buying price of goods).

OR: get from both parties.

The % number is temporary only, and it will be considered carefully later to have a suited % number.

8. Payment Methods:

Buyers pay in full (buying price+2%) to VITA Bank Account (market maker) and VITA pay-back to Seller (subtract 1% of total contract value) AFTER Seller has delivered out goods to Buyers. (Time: 5 days ˜7 days: similar to PayPal)

Payment by Paypal, Telex Transfer, Credit Card through Banks, by Cash, etc. . . . .

Member VIP: Maybe deposit to VITA about 20,000,000 VND/1,500 USD to get a right to participate immediately, quickly in auction to buy OR Sale goods at near ending time of auction lot.

IN USA: Depend on USA Commercial Law, maybe no need deposit (for Sellers-Bs as well as Buyers-Cs), but base on Rating of Member: o o o o o_o o o o o (picture of 10 Gold Currency Coins)

What is claimed is:

1. A new principle, method, process of on-line auction—the Motion Reverse Auction, that is on-line auction with quantities are always changed, increasing to the end of auction time, in order to sure that those Buyers will have lowest buying price. The principle, method, process of on-line Motion Reverse Auction comprising:
divided an auction lot by many non-continuous auction times/rounds, between them are waiting periods of time without any bidding auctions.
demand quantity for buying-selling are changed in waiting periods, with tendency towards increase.
waiting list is a place where (existing, new) offer request, changes their demand to buy goods (about quantity, wishing buy price) in waiting periods of time between auction rounds.
new principle is: If buyers invite/lead more and more, as much other/new buyers (for the same kind of goods) then opportunity to have as lower price of the goods.
there will be MANY Buyers have goods (not only ONE final buyer have goods in old/existing auction methods) when an Motion Reverse Auction had closed.
final winner of auction round is seller not only with lowest selling price but much have a big enough quantity of goods.
there is SaleItNow price.
principle which will help seller (if he choose SaleItNow option) to meet their demand/wish to sales quickly, but also to help this seller with his limited quantity will win a bid in time with quantity he having, but have to accept to sale with 10% lower price than current selling price of temporary winner—with same quantity.
value of SaleItNow price are always changed and decrease with time.
products/goods on the Motion Reverse Auction floor have to be identical type: same model, 100% brand-new, new in box, never used, manufactured on 2xxx year, etc. . . . .
both buyers and sellers have to pay a deposit.
particularity of VIP member, that is there are available enough amount in their accounts on Motion Reverse Auction floor.
goods quantity of auction are always changed

2. The principle, method, process of claim 1, wherein dividing auction lot by many non-continuous auction times/rounds, between them are waiting periods of time without any bidding actions.

3. The principle, method, process of claim 2, wherein there are waiting periods in which, demand quantity for buying-selling are changed with tendency towards increase.

4. The principle, method, process of claim 3, wherein new principle is if buyers invite/lead more and more, as much other/new buyers (for the same kind of goods) then opportunity to have as lower price of the goods.

5. The principle, method, process of claim 4, wherein final buying-selling price is depended on both sellers and buyers, in direction as more buyers as cheaper price.

6. The principle, method, process of claim 3, wherein Waiting List is a place where (existing, new) offer request, changes their demand to buy goods (about quantity, wishing buy price) in waiting periods of time between auction rounds.

7. The principle, method, process of claim 6, the Waiting List further is helpful information for sellers when they considering offer bid, beside information about current bidding prices and current supplying quantity of competitors—other sellers (in bidding period of time).

8. The principle, method, process of claim 2, wherein there is SaleItNow price. SaleItNow is finishing price for transaction/auction round and go to the end right away, help to meet right away demand/wish of Buyer Party meanwhile Seller Party also meet demand/wish to sales quickly.

9. The principle, method, process of claim 8, the SaleItNow price further having a value that always be set up right after having temporary winning result (with temporary Winner) in auction times/rounds and have value is 10% lower than current selling price, with existing selling quantity (Later on, Motion Reverse Auction program will configures: includes new adding quantities OR only quantities of temporary winner).

10. The principle, method, process of claim 9, the value of SaleItNow price further are always changed and decrease with time.

11. The principle, method, process of claim 8, wherein principle, that is due to competition between sellers about also goods quantity they have and be able to supply beside pricing factor, so if a seller choose SaleItNow option, beside finishing transaction immediately to help seller to meet their demand/wish to sales quickly, but also to help sellers with his limited quantity will win a bid in time with quantity he having but they have to accept to sale with 10% lower price than current selling price of temporary winner—with same quantity (because if he let auction round in being longer time, then competitive sellers who have bigger quantity will get an advantage over him/someone else; and when requested quantity be over quantity he having then basically he will not be able to come on the bid, unless he accept to re-buy more from other seller later).

12. The principle, method, process of claim 2, wherein particularity of VIP member, that is there are available enough amount in their accounts on Motion Reverse Auction floor in order always have right to participate (buy-sale) at any time for a commodity they interest in without lose time to pay a deposit and lose opportunity to participate when bid time go nearly the end time (i.e. when period of time from register to moment be confirmed paid a deposit are more/bigger than period of left time of interesting bid).

13. The principle, method, process of claim 1, wherein Buyers request themselves about quantity but buying price is depended on seller. Buyers offer only wishing price to buy (ceiling—reserve price) but can not negotiate/bid buying prices. Final buying price is bided by sellers but it is mostly depended on requested goods quantities from buyers.

14. A new principle, method, process of on-line auction—the Motion Reverse Auction, that is on-line auction with quantities are always changed, increasing to the end of auction time, in order to sure that those Buyers will have lowest buying price. The principle, method, process of on-line Motion Reverse Auction comprising:
divided an auction lot by many non-continuous auction times/rounds, between them are waiting periods of time without any bidding auctions.
demand quantity for buying-selling are changed in waiting periods, with tendency towards increase.
waiting list is a place where (existing, new) offer request, changes their demand to buy goods (about quantity, wishing buy price) in waiting periods of time between auction rounds.
new principle is: If buyers invite/lead more and more, as much other/new buyers (for the same kind of goods) then opportunity to have as lower price of the goods.
there will be MANY Buyers have goods (not only ONE final buyer have goods in old/existing auction methods) when an Motion Reverse Auction had closed.
final Winner of auction round is seller not only with lowest selling price but much have a big enough quantity of goods.
there is SaleItNow price.
principle which will help seller (if he choose SaleItNow option) to meet their demand/wish to sales quickly, but also to help this seller with his limited quantity will win a bid in time with quantity he having, but have to accept to sale with 10% lower price than current selling price of temporary winner—with same quantity.
value of SaleItNow price are always changed and decrease with time.
products/goods on the Motion Reverse Auction floor have to be identical type: same model, 100% brand-new, new in box, never used, manufactured on 2xxx year, etc. . . . .
both buyers and sellers have to pay a deposit.
particularity of VIP member, that is there are available enough amount in their accounts on Motion Reverse Auction floor.
goods quantity of auction are always changed
principle, method, process in which, Suppliers (Bidders) when participating to Motion Reverse Auction must consider and bid on price and quantity, not on price only.

15. The principle, method, process of claim 14, wherein sellers offer themselves about price but quantity is always changed increasingly and this quantity is depended on buyers, at price which sellers want to sale.

16. The principle, method, process of claim 14, wherein the final winner of auction round is a seller not only with lowest selling price but much have a big enough quantity of goods. Seller with lower selling price AND big quantity of goods then have more opportunities to become the final winner.

17. The principle, method, process of claim 14, wherein a finished auction lot will lead to result that a biggest quantity of goods were sold out with possible lowest price, that mean it encourages trading transactions with huge selling quantity (in Sellers side) and huge buyers will have lowest buying price together for the same one (01) product/goods.

18. The principle, method, process of claim 14, wherein both buyers and sellers have to pay a deposit: Because particularity of transaction is at the finishing time (i.e. have official transaction contracts) there will be many buyers (Customers) and large goods quantity will be supplied by bid winning seller (winner), with correlative winning price, so in order to ensure highest interests for every buyers as well as every sellers, pay a deposit policies are applied and those deposit amount will be taken from cancelling parties (cancel themselves to perform transaction contracts) and be shared equally to remaining parties of contracts.

19. A new principle, method, process of on-line auction—the Motion Reverse Auction, that is on-line auction with quantities are always changed, increasing to the end of auction time, in order to sure that those Buyers will have lowest buying price. The principle, method, process of on-line Motion Reverse Auction comprising:
divided an auction lot by many non-continuous auction times/rounds, between them are waiting periods of time without any bidding auctions.
demand quantity for buying-selling are changed in waiting periods, with tendency towards increase.
waiting list is a place where (existing, new) offer request, changes their demand to buy goods (about quantity, wishing buy price) in waiting periods of time between auction rounds.
new principle is: If buyers invite/lead more and more, as much other/new buyers (for the same kind of goods) then opportunity to have as lower price of the goods.
there will be MANY Buyers have goods (not only ONE final buyer have goods in old/existing auction methods) when an Motion Reverse Auction had closed.
final Winner of auction round is seller not only with lowest selling price but much have a big enough quantity of goods.
there is SaleItNow price.
principle which will help seller (if he choose SaleItNow option) to meet their demand/wish to sales quickly, but also to help this seller with his limited quantity will win a bid in time with quantity he having, but have to accept to sale with 10% lower price than current selling price of temporary winner—with same quantity.
value of SaleItNow price are always changed and decrease with time.
products/goods on the Motion Reverse Auction floor have to be identical type: same model, 100% brand-new, new in box, never used, manufactured on 2xxx year, etc. . . . .
both buyers and sellers have to pay a deposit.
particularity of VIP member, that is there are available enough amount in their accounts on Motion Reverse Auction floor.
goods quantity of auction are always changed
principle, method, process in which, Suppliers (Bidders) when participating to Motion Reverse Auction must consider and bid on price and quantity, not on price only.
use new e-commerce method Bs2Cs (Business' To Customers) is a new way in trading transaction by which, many Business(S) serve to many Customer(S).

20. The method of claim 19, wherein when a Motion Reverse Auction closed, there will be many buyers have goods (not only one final buyer have goods in old/existing auction methods).

21. The method of claim 19, wherein for Buyers: Many buyers located in different locations/regions may participate to buy a same kind of goods with buying price as low as possible. This advantage only available in Internet Communication environment nowadays; in the past, it could not available.

22. The method of claim 21, the buyers located in different locations/regions further may setting up different Motion Reverse Auction to buy a same kind of goods at their location address.

23. The method of claim 19, wherein for Sellers: Sold directly with big quantity from their warehouses/stocks/stores, to a huge group of buyers having goods receiving address at (or nearly) their warehouses/stocks/stores; help to optimality process of manufacture and sale of products.

24. The method of claim 19, wherein Goods on the Motion Reverse Auction floor have to be identical type: Because particularity of transaction is many buyers and many sellers participate together, so in order to have justice between sellers and no disputes about quality of goods between sellers and buyers, then goods on the Motion Reverse Auction floor have to be identical type (Example: same model, 100% brand-new, new in box, never used, manufactured on 2xxx year, . . . ).
